(19) United States
(12) Patent Application Publication
(10) Pub. No.: US 2017/0232984 A1
(43) Pub. Date: Aug. 17, 2017

(54) Driving assistance device for a railway vehicle

(71) Applicant: ALSTOM TRANSPORT TECHNOLOGIES, Saint-Ouen (FR)

(72) Inventors: Denis MIGLIANICO, PARIS (FR); Samuel HIBON, LE MANS (FR); Ludovic LE-ROUX, LA ROCHELLE (FR)

(21) Appl. No.: 15/432,494

(22) Filed: Feb. 14, 2017

(30) Foreign Application Priority Data
Feb. 15, 2016 (FR) 16 51190

(51) Int. Cl. B61L 15/00; B61L 25/02; G01P 3/56; B61L 27/04

(52) U.S. Cl. CPC B61L 15/0081; B61L 27/04; B61L 25/021; B61L 15/009; B61L 15/0072; B61L 25/025; G01P 3/56; B61L 2205/04

(57) ABSTRACT

The driving assistance device (10) for a railway vehicle comprises means (12) for determining a target speed (V_{c}), means (20) for comparing an instantaneous speed (Vᵢ) of the railway vehicle with the target speed (V_{c}) or an interval surrounding the target speed, and means (22) for indicating driving instructions intended for a driver of the railway vehicle, said driving instructions including instructions for modifying the instantaneous speed (Vᵢ) with view to bringing it closer to the target speed (V_{c}).

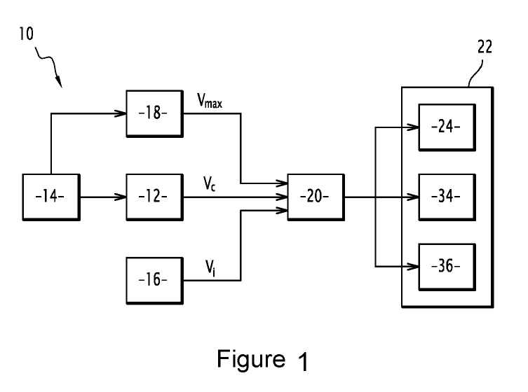

The present invention relates to a driving assistance device for a railway vehicle.

The energy consumption of a railway vehicle is directly related to the speed of the latter. Thus, there exist methods for determining an optimum speed for the railway vehicle, giving the possibility of minimizing the energy consumption of this vehicle, while meeting the schedule requirements which a railway vehicle usually has to observe.

In the state of the art, a driving assistance device is already known for a railway vehicle, including means for determining such an optimum speed. The driving assistance device moreover includes means for indicating this optimum speed to the driver, so that he/she takes it into account when driving the vehicle.

The object of the invention is notably to improve such a driving assistance device, notably by facilitating its use for the driver.

For this purpose, the object of the invention is notably a driving assistance device for a railway vehicle, comprising means for determining a target speed, characterized in that it includes:

means for comparing an instantaneous speed of the railway vehicle with the target speed or with an interval surrounding the target speed, and

means for indicating driving instructions intended for a driver of the railway vehicle, said driving instructions including instructions for modifying the instantaneous speed with view to bringing it closer to the target speed,

and in that the target speed is determined on a track segment in one of the following ways:

the target speed is predetermined, by a preliminary calculation, taking into account the energy consumption of the railway vehicle and the schedules which have to be observed by this railway vehicle, and preferably features of the vehicle, features of the relevant track segment and environmental conditions;

the target speed is calculated in real time, taking into account the energy consumption of the railway vehicle and the schedules which have to be observed by this railway vehicle, and preferably features of the vehicle, features of the relevant track segment and environmental conditions; or

the target speed is defined by learning means recording during each path the speed of the vehicle on the relevant track segment, and then selecting the most suitable speed from among those recorded on this track segment.

Such a device gives the possibility to the driver of taking into account in a very simplified way, the optimum speed notably in order to optimize the energy consumption of the railway vehicle. In particular, the device according to the invention directly indicates to the driver the action to be carried out (notably increase, maintain or reduce the speed), rather than only indicating a target speed which the driver will have to consider in addition to the other usual parameters to be taken into account when he/she drives the vehicle.

A device for driving assistance according to the invention may further include one or several of the following features, taken alone or according to all the technically conceivable combinations.

The indication means include a display panel, able to display the driving instructions.

The indication means include a head-up display device, able to display the driving instructions in a field of view of the driver.

The comparison means compare the instantaneous speed with an interval surrounding the target speed, and the means for indicating driving instructions are configured for:

indicating an instruction for increasing the speed when the instantaneous speed is below the interval,

indicating an instruction for reducing the speed when the instantaneous speed is above the interval,

indicating an instruction for maintaining the speed when the instantaneous speed is found in the interval.

The comparison means also compare the instantaneous speed with a maximum speed, and the means for indicating driving instructions are configured for indicating an imperative instruction for reducing the speed when the instantaneous speed is greater than the maximum speed.

The invention also relates to a method for assistance in the driving of a railway vehicle, by means of a driving assistance device as defined earlier, characterized in that it includes:

a step for determining a target speed,

a step for comparing an instantaneous speed of the railway vehicle with the target speed or an interval surrounding the target speed, and

a step for indicating driving instructions intended for a driver of the railway vehicle, said driving instructions including instructions for modifying the instantaneous speed in order to bring it closer to the target speed.

The invention will be better understood upon reading the description which follows, only given as an example and made with reference to the appended figure schematically illustrating a driving assistance device according to an exemplary embodiment of the invention.

In the figure, a driving assistance device 10 is illustrated, intended to equip a railway vehicle.

As a railway vehicle is intended to circulate on a railway track, it follows a predefined path, so that it is possible to provide an optimum displacement speed of the railway vehicle, notably in order to minimize the energy consumption of the vehicle, while taking into account the schedules which this vehicle has to observe.

More particularly, the railway track may be cut-up into a plurality of track segments, an optimum speed may be defined on each segment. Indeed, the optimum speed is usually different depending on the segment on which the railway vehicle is found, notably depending on the fact that the segment is in a straight or curved line, in a descent or in an ascent, etc. The length of a track segment is selected during the configuration of the driving assistance device 10, and may be any value. It is also possible to provide diverse segment segments with different lengths.

Thus, the driving assistance device 10 according to the invention includes means 12 for determining a target speed V_{c}, for example corresponding to an optimum speed allowing limitation of the energy consumption of the railway vehicle.

As indicated earlier, the optimum speed depends on the track segment on which the railway vehicle is found, so that it is necessary to be able to determine on which track segment the railway vehicle is found. For this purpose, the driving assistance device 10 advantageously includes localization means 14, for example a satellite guidance device.

The determination means 12 may be of any conceivable type.

According to a first example, these determination means 12 are formed by a memory in which is stored, for each track segment, a target speed V_{c} (notably an optimum speed) which is predetermined, corresponding to this track segment. Thus, at any moment, the localization means 14 give the possibility of determining on which track segment the railway vehicle is found, and the determination means 12 infer therefrom the target speed V_{c}.

Each predetermined target speed V_{c} is calculated beforehand, by taking into account the energy consumption of the railway vehicle and the schedules which have to be observed by this railway vehicle. Other features may be taken into account for determining the target speed V_{c}, notably the features of the vehicle (such as its number of carriages and its length), features of the relevant track segment (notably if it includes at least one ascent and/or at least one descent, whether it is in a straight line or whether it includes curves, in which case the radii of curvature of these curves may also be taken into account) as well as environmental conditions (for example the season).

In accordance with a second example, the determination means 12 include means for calculating in real time the target speed V_{c}, comprising a calculation algorithm determining the target speed V_{c} according to the features mentioned earlier. Such real time calculation means may also take into account a possible delay or an advance on the schedules which the railway vehicle has to observe.

According to a third example, the determination means 12 include learning means. In this case, when the railway vehicle covers the railway track, the learning means record at each travel the speed of the railway vehicle on each relevant track segment. Next, during the subsequent travels, the learning means select, on each track segment, the speed which seems to be the most suitable from among those recorded on this segment, this speed most adapted then forming the target speed V_{c}.

The driving assistance device 10 moreover includes standard control means as regards traction 16, generally formed by a control lever for traction/braking. This control lever 16 is actuated by the driver of the railway vehicle, in order to apply to this railway vehicle a traction or braking level allowing it to modify the instantaneous speed Vᵢ desired by the driver, with view to approaching the target speed V_{c}.

The driving assistance device also includes means 18 for determining a maximum speed Vₘₐₓ, depending on the track segment on which the railway vehicle is found.

These means 18 for determining a maximum speed Vₘₐₓ are bound to the localization means 14 indicating on which track segment is found the railway vehicle, so that the means 18 for determining a maximum speed infer therefrom which is the maximum speed Vₘₐₓ allowed for the railway vehicle.

The means 18 for determining a maximum speed for example include a database in which a predetermined respective maximum speed Vₘₐₓ is determined for each track segment.

Alternatively, the maximum speed Vₘₐₓ may be provided in real time by a centralized control center, or by milestones positioned along the railway track.

The driving assistance device 10 moreover includes means 20 for comparing the instantaneous speed Vᵢ of the railway vehicle, depending on the control means 16, with the target speed V_{c} determined by the determination means 12. Advantageously, a target speed interval is defined around the target speed V_{c}, and the comparison means 20 compare the instantaneous speed Vᵢ with this target speed interval.

Advantageously, these comparison means 20 also compare the instantaneous speed Vₗ with the maximum speed Vₘₐₓ determined by the determination means 18.

These comparison means 20 provide the results of the comparisons to means 22 for indicating driving instructions intended for the driver of the railway vehicle.

These driving instructions notably include instructions for modifying the instantaneous speed Vᵢ with view to bringing it closer to the target speed V_{c}. More particularly, the indication means 22 are configured for indicating an instruction for increasing the speed when the instantaneous speed Vᵢ is below the target speed interval V_{c}, indicating an instruction for reducing the speed when the instantaneous speed Vᵢ is above the target speed interval V_{c}, and indicating an instruction for maintaining the speed when the instantaneous speed Vᵢ is found in the target speed interval V_{c}.

Moreover, when the instantaneous speed Vᵢ is greater than the maximum speed Vₘₐₓ, the means for indicating instructions 22 indicate an imperative instruction for reducing speed.

Advantageously, the indication means 22 also indicate the values of the instantaneous speed Vᵢ, of the target speed V_{c}, and of the maximum speed Vₘₐₓ.

The indication means 22 may include different conceivable indication devices.

For example, the indication means 22 include a display panel 24, notably a display screen, able to display the driving instructions.

Alternatively or additionally, the indication means 22 include a head-up display device 34, able to display the driving instructions in a field of view of the driver. Such a head-up display device 34 is known per se and will therefore not be described in more detail.

The instructions displayed by the head-up display device 34 are for example identical with those displayed by the display panel 24.

Alternatively, or additionally, the means for indicating instructions 22 include means audio 36, indicating with sound instructions for modifying or maintaining the instantaneous speed.

The driving assistance device 10 gives the possibility of achieving a driving assistance method, including the following steps:

a step for determining a target speed V_{c} (with the determination means 12),

a step for comparing an instantaneous speed Vᵢ of the railway vehicle with the target speed V_{c} (with the comparison means 20), and

a step for indicating driving instructions intended for the driver of the railway vehicle, the driving instructions including instructions for modifying the instantaneous speed Vᵢ with view to bringing it closer to the target speed V_{c} (with the indication means 22).

It will be noted that the invention is not limited to the embodiment described earlier, but may have various alternatives.

In particular, the target speed may be determined with other criteria than the optimum speed mentioned earlier. For example, the target speed may take into account exclusively the schedules to be observed, or exclusively the energy consumption.

1. A driving assistance device for assisting driving for a railway vehicle, comprising a speed determining unit for determining a target speed, wherein the driving assistance device includes:
a comparison unit for comparing an instantaneous speed of the railway vehicle with the target speed or with an interval surrounding the target speed, and
an indication unit for indicating driving instructions intended for a driver of the railway vehicle, said driving instructions including instructions for modifying the instantaneous speed with view to bringing it closer to the target speed,
and wherein the target speed is determined on a track segment in one of the following ways:
the target speed is predetermined, by calculation beforehand, taking into account the energy consumption of the railway vehicle and the schedules which have to be observed by this railway vehicle, and preferably features of the vehicle, features of the relevant track segment and environmental conditions;
the target speed is calculated in real time, taking into account the energy consumption of the railway vehicle and the schedules which have to be observed by this railway vehicle, and preferably features of the vehicle, features of the relevant track segment and environmental conditions; or
the target speed is defined by a learning unit recording at each travel, the speed of the vehicle on the relevant track segment, and then by selecting the most adapted speed from among those recorded on this track segment.

2. The driving assistance device according to claim 1, wherein the indication unit includes a display panel, able to display the driving instructions.

3. The driving assistance device according to claim 1, wherein the indication unit includes a head-up display device, able to display the driving instructions in a field of view of the driver.

4. The driving assistance device according to claim 1, wherein the indication unit includes an audio unit, able to indicate with sound instructions for modifying or maintaining the instantaneous speed.

5. The driving assistance device according to claim 1, wherein the comparison unit compares the instantaneous speed with an interval surrounding the target speed, and the indication unit is configured for:
indicating an instruction for increasing the speed when the instantaneous speed is below the interval,
indicating an instruction for reducing the speed when the instantaneous speed is above the interval,
indicating an instruction for maintaining the speed when the instantaneous speed is found in the interval.

6. The driving assistance device according to claim 1, wherein the comparison unit also compare the instantaneous speed with a maximum speed, and the indication unit are configured for indicating an imperative instruction for reducing the speed when the instantaneous speed is greater than the maximum speed.

7. A driving assistance method of a railway vehicle, by means of a driving assistance device comprising a speed determining unit for determining a target speed, the driving assistance device further including:
a comparison unit for comparing an instantaneous speed of the railway vehicle with the target speed or with an interval surrounding the target speed, and
an indication unit for indicating driving instructions intended for a driver of the railway vehicle, said driving instructions including instructions for modifying the instantaneous speed with view to bringing it closer to the target speed, wherein the driving assistance method includes:
determining a target speed, on a track segment in one of the following ways:
the target speed is predetermined, by calculation beforehand, taking into account the energy consumption of the railway vehicle and the schedules which have to be observed by this railway vehicle, and preferably features of the vehicle, features of the relevant track segment and environmental conditions;
the target speed is calculated in real time, taking into account the energy consumption of the railway vehicle and the schedules which have to be observed by this railway vehicle, and preferably features of the vehicle, features of the relevant track segment and environmental conditions; or
the target speed is defined by a learning unit recording at each travel, the speed of the vehicle on the relevant track segment, and then by selecting the most adapted speed from among those recorded on this track segment,
comparing an instantaneous speed of the railway vehicle with the target speed or an interval surrounding the target speed, and
indicating driving instructions intended for a driver of the railway vehicle, said driving instructions including instructions for modifying the instantaneous speed with view to bringing it closer to the target speed.
